(19) United States
(12) Patent Application Publication
(10) Pub. No.: US 2011/0314682 A1
(43) Pub. Date: Dec. 29, 2011

(54) QUICK-TIGHTENING DEVICE FOR A CHAIN SAW AND CHAIN UNIT FOR SAME

(76) Inventors: Markus Maag, Neu-Ulm (DE); Michael Kistler, Ulm (DE)

(21) Appl. No.: 13/256,255

(22) PCT Filed: Mar. 17, 2010
(86) PCT No.: PCT/EP2010/001668

§ 371 Date: Sep. 13, 2011

(30) Foreign Application Priority Data
Mar. 18, 2009 (DE) 10 2009 013 450.6

(51) Int. Cl. B27B 17/14

(52) U.S. Cl. 30/386

(57) ABSTRACT

The invention relates to a rapid tensioning apparatus as well as to a chain unit and a sword suitable for it, by means of which the placing of saw chain and sword on the main body of the chain saw can be readily carried out and a tensioning of the saw chain is made possible without problems.

In the rapid tensioning apparatus a wedge is mounted on the sword of the chain saw whereas a movable tensioning lever arrangement comprising a counterwedge is positioned on the chassis in the area of the drive shaft. In a special manner the course of the movement of the elements of the tensioning lever arrangement in the transition from the open position to the closed position is designed in such a manner that the counterwedge acts on the wedge mounted on the sword and secures the sword on the chassis by contact pressure. At the same time the sword is pushed longitudinally in the direction away from the drive pinion here by the pushing pressure so that the saw chain is tensioned.

The invention relates to a rapid tensioning apparatus, a chain unit and a sword for a chain saw according to the generic parts of Claims 1, 17 and 18.

Known chain saws comprise a main body with one or more handles for holding the chain saw when using it and with a chain saw/sword arrangement that is removably fastened on the main body. A drive unit, in particular an electrical or combustion motor is present in the main body and which drives a drive pinion that is connected to the chain saw in order to drive it. The sword is a substantially longitudinally extended, rectangular and flat body with a rounded-off end that has a guide groove on its outer edge for guiding the saw chain.

Traditional chain saws have a number of disadvantages as regards a desired, simple operation. For example, a chain saw is generally offered in trade packed in such a manner that its sword and chain are located as separate parts next to the main body in the package so that the customer must join the parts together himself before starting up the saw. This is frequently not easy, even for an experienced user. For this, usually a housing cover located on the housing, which covers the chain drive during the operation of the saw, must first be removed from the main body. This is often not possible without tools. Subsequently, the saw chain must now be looped around the sword in such a manner that it runs in the guide groove of the sword. Only now can the sword with the saw chain present on it be connected to the main body of the chain saw. Care must be taken here that the saw chain does not slide out of the guide groove in the sword as well as that the saw chain lies correctly on the drive pinion connected to the drive unit.

Following this assembly, the housing cover can then be put back on, whereby it cannot yet be secured in its final position since the tensioning of the saw chain on the sword has to be correctly adjusted beforehand. This is necessary for reasons of safety but also for optimizing the saw properties. Otherwise, there is in particular the danger that the saw chain jumps from the sword during the operation of the chain saw and severely injures the operator. However, a manual adjustment of the optimal chain tension is difficult and requires experience and practice. In traditional chain saws the tensioning of the chain is frequently possible via a lever located on the chain saw. After the completion of the tensioning the housing is completely secured in its end position and serves in this manner for fixing the sword between the machine and the housing cover.

Since the chain saw as well as the sword wear down and become dull in the course of operation, they must be regularly removed from the main body of the chain saw for maintenance and cleaning activities. Thus, a frequent and repeated using of the saw chain associated with the need to retighten it results over the service life of a chain saw.

Also, the saw chain will lengthen in the course of time by the traction load acting on it during operation so that even then when the saw chain and the sword remain in the saw chain for a rather long time a regular retightening of the saw chain becomes necessary in order to continuously guarantee optimal safety and cutting effect. In particular inexperienced users are frequently overtaxed with this retightening of the saw chain. For this, as a rule the housing cover must be separated from its secured position in order to move the sword so far by a suitable extent that the tension of the saw chain running on it can be corrected again. Following this, the housing cover must again be secured on the main body for fixing the sword.

The invention therefore has the task of further developing a chain saw or parts of it in such a manner that the positioning of saw chain and sword on the main body can be brought about in a simple manner and that a smooth tensioning of the saw chain is made possible.

The task is solved on the one hand with a rapid tensioning apparatus with the features of Claim 1. Furthermore, the task is solved with a chain unit in accordance with the features of Claim 17 as well as with the sword according to the features of Claim 18. Advantageous embodiments and further developments of the invention are described by the particular subclaims.

In the rapid tensioning apparatus in accordance with the invention for a chain saw with a drive unit for driving a saw chain running over a sword and a drive pinion the drive pinion is connected via a drive shaft to the drive unit. The chassis of the chain saw is provided with support surfaces on which the sword comes to rest on the main body in a shiftable manner during its assembly. A wedge is mounted on the sword whereas a movable tensioning lever arrangement comprising a counterwedge is mounted on the chassis in the area of the driveshaft, which counterwedge cooperates with the wedge mounted on the sword. The cooperation of wedge and counterwedge brings about the securing of the sword on the chain saw and at the same time the tensioning of the saw chain because a contact pressure that presses the sword on the chassis as well as a pushing pressure that pushes the sword away from the drive pinion are produced by the action of the two wedges acting on one another on a surface inclined opposite the surface normal of the chassis of the chain saw.

In the framework of the automatic tensioning-and securing procedure the tensioning lever arrangement has on the one hand an open position in which at least the saw chain and the sword can be disassembled from the main body of the chain saw and on the other hand a closed position in which the saw chain rests tensioned on the drive pinion and on the sword and the sword is firmly secured on the chassis of the main body.

A drive shaft connected to the drive unit of the chain saw extends from the chassis of the main body. In a possible embodiment of the invention the drive pinion is not placed on this drive shaft, for example, by insertion, until during the assembly of the chain unit on the chassis of the chain saw. In another possible embodiment of the invention a drive pinion is already placed on the drive shaft before the assembly of a sword in accordance with the invention so that the saw chain is laid around the drive pinion during or after the assembly of this sword.

In the chain unit of the invention the sword, the saw chain and the drive pinion driving the saw chain form a structural unit. A wedge and a spacer are mounted on the sword. The spacer is mounted so that it can move in the longitudinal direction of the sword and is braced relative to the sword by spring power. The direction of the spring power is aligned in the direction of the drive pinion in such a manner that the spacer presses or pulls the drive pinion from the sword in the direction of the chain by the spring power. In this manner the drive pinion is held between chain and sword with engagement into the chain. At the same time the pressure force exerted by the spacer on the drive pinion brings it about that the saw chain is held by traction so that it does not automatically slide out of the guide groove in the sword. A support surface is preferably formed on the drive pinion around its axis of rotation on which surface the spacer comes to rest.

In a possible embodiment of the chain unit in accordance with the invention the wedge is firmly secured on the sword. In an alternative embodiment of the chain unit to the above the wedge is mounted on the one hand so that it can move relative to the sword along its longitudinal axis as well as being movably mounted relative to the spacer. In an especially advantageous manner the wedge is connected to the sword via microcoggings.

A wedge is mounted on the sword in accordance with the invention and suited for use in the previously described chain unit. In a possible embodiment of the sword in accordance with the invention the wedge is firmly secured on the sword.

In another alternative embodiment of the sword the wedge is movably mounted relative to the sword along its longitudinal axis. In an especially advantageous manner the wedge is connected to the sword here via microcoggings. Thus, the bottom of the wedge resting on the sword is provided with a microcogging. A corresponding microcogging is applied along the longitudinal sections on the top of the sword on which the wedge can move. The microcogging is preferably designed in such a manner that the wedge can be shifted relative to the sword in only one direction along its longitudinal axis (this is in the direction of the drive pinion in the assembled sword.

The sword preferably also comprises, in addition to the wedge, a spacer mounted so that it can move in the longitudinal direction of the sword.

In a first advantageous embodiment of the rapid tensioning apparatus of the invention a counterholder is constructed on the chassis in the area of the support surface for the sword and preferably projects vertically over this support surface. In order to cooperate with this counterholder, preferably the middle part of the wedge mounted on the sword as well as the area of the sword located under this middle part in a corresponding manner are recessed in such a manner that when the chain unit is placed on the support surface the counterholder can penetrate through the wedge in this recess and consequently projects over the wedge. In order to support the adjusting of the sword on the chassis of the chain saw the recess in the wedge as well as in the area of the sword located underneath it should preferably be constructed as a longitudinal groove into which an elongated spring located on the chassis below the counterholder can engage.

In a special manner the course of the movement of the elements of the tensioning lever arrangement in the transition from the open position to the closed position is designed in such a manner that the counterwedge slides over the wedge mounted on the sword and secures the sword on this chassis, held by the counterholder by contact pressure. As a result, the sword is pushed at the same time longitudinally in the direction away from the drive pinion so that the saw chain is tensioned.

The tensioning lever arrangement for tensioning the saw chain and securing the sword on this chassis advantageously comprises a cover that can also be formed, for example, directly by the housing cover that covers the chain drive during the operation of the saw. A rocker arm is attached on the cover pivotably supported on the chassis by means of which rocker arm the rotary movement of the cover is transformed into a longitudinal movement of the rod. For its part, this rod is connected to a counterwedge and thus furthers its rotary and longitudinal movement.

If the cover is pivoted in the direction of the chain unit set on the main body of the chainsaw (toward the closed position of the tensioning lever arrangement), even the counterwedge is pivoted in a first step onto the wedge mounted on the sword. Then, the connection realized by the rocker arm and the rod between cover and counterwedge brings about a longitudinal shifting of the counterwedge on the wedge, during which the counterwedge slides under the counterholder mounted on the chassis and projecting over the wedge on the sword. This brings it about that the counterwedge is pressed with increasing longitudinal shifting onto the wedge. This brings it about that the longitudinal movement of the counterwedge is also transferred onto the sword via the wedge mounted on the sword. At the same time the pressing effect acting vertically on the chassis and which the counterholder produces between the counterwedge and the wedge produces a securing of the chain unit on the main body of the chain saw. The pressing effect between wedge and counterwedge furthermore brings about a longitudinal shift of the sword in the direction away from the drive pinion, so that the saw chain is tensioned.

For the case that a spring formed on the chassis extends into a groove located in the notch in the wedge and the sword for an improved adjusting of the sword, it is advantageous to provide this spring with a slot into which the spacer can penetrate in an unimpeded manner during a longitudinal shift.

In a possible variant of the first advantageous embodiment of the rapid tensioning apparatus of the invention the rod with which the movement of the cover is transferred onto the counterwedge is pre-tensioned with one or more springs so that the spring power supports the longitudinal movement of the rod. Furthermore, the cooperation between cover and counterwedge can be advantageously improved in that a movably mounted connecting web is introduced between both structural parts.

In an alternative variant of the first advantageous embodiment of the rapid tensioning apparatus in accordance with the invention the longitudinal movement of the rod by means of which the rotary movement of the cover is transferred onto the counterwedge is supported by a lever and/or a clamping mechanism.

The clamping mechanism can be designed in such a manner that it is actuated by a rocker arm connected to the cover of the tensioning lever arrangement and acts on the rod connected to the counterwedge. The clamping mechanism brings it about that a fictional connection is adjusted between cover and rod which connection supports the transfer of the rotational movement of the cover into a linear movement of the rod. In this manner the counterwedge is moved toward the wedge located on the sword so that this wedge is secured with a main body of the chainsaw and the saw chain is tensioned.

In order to loosen the securing of the sword on the chassis of the chain saw the counterwedge is redrawn from the wedge mounted on the sword by a longitudinal movement of the rod, during which the longitudinal movement of the rod is initially supported by the clamping mechanism acting between cover and rod. In the further course the rotational movement of the cover is transferred onto the rod by a lever movably fastened on this cover. During this time this lever exerts a pressure force on a stop fastened on the rod so that as a result the rotary movement of the cover is also transformed into a linear movement of the rod.

In order to improve the frictional connection by means of the clamping mechanism there is the opportunity of constructing the rod in the area in which it cooperates with the clamping mechanism in an advantageous manner with a gripping, especially grooved surface. It is also conceivable to construct the rod in an advantageous manner at least in the area of the cooperation with the clamping mechanism with an elliptical cross section. Alternatively and in a corresponding manner, in the case of a circular cross section of the rod even the clamping mechanism can be designed in such a manner that in it the cross section of the passage for the rod is constructed elliptically.

The cover of the tensioning lever arrangement is preferably provided with a fastening element with which it is automatically or manually fastened on the chassis of the chain saw after the conclusion of the securing and tensioning procedure.

In a second advantageous embodiment of the rapid tensioning apparatus of the invention the counterwedge and a locking lever are attached on the cover, that is pivotably mounted on the chassis of the chain saw. The locking lever is pivotably supported relative to the cover.

In order to cooperate with this locking lever a locking pin is formed on the chassis. This locking pin extends in the area of the support surface and projects preferably vertically over it, approximately corresponding to the counterholder in the previously described first advantageous embodiment of the rapid tensioning apparatus. In order to be able to cooperate with the locking lever the locking pin is advantageously provided with a recess into which a preferably hook-shaped formation on the locking lever can engage. The surfaces of locking lever and locking pin, which surfaces act on one another, are to be designed in such a manner that during the pivoting of the locking lever into the locking position the counterwedge located on the cover is pressed onto the wedge mounted on the sword. This pressing effect acting on the chassis, which effect is generated between counterwedge and wedge, brings about a securing of the chain unit on the main body of the chain saw. Furthermore, the pressing effect brings about a longitudinal shifting of the sword in the direction away from the drive pinion, so that the saw chain is tensioned.

In the sword cooperating with this embodiment of the rapid tensioning apparatus a spacer is movably mounted on the sword and is pre-tensioned by springs in the direction of the drive pinion for the saw chain. The wedge cooperating with the counterwedge on the cover of the tensioning lever arrangement is fastened here so that it can move in a sliding manner on the sword. This wedge is advantageously connected to the spacer in such a manner that when the spacer slides after the opening of the tensioning lever arrangement in the direction of the drive pinion, it is also pushed or drawn in this direction by the spacer. Of course, it would also be conceivable as an alternative to pre-tension the wedge itself, that is fastened on the sword in a shiftable manner, in the direction of the drive pinion with a spring force.

The wedge and the sword are preferably connected to one another by a microcogging in order to be able during the closing of the tensioning lever arrangement to turn the pressing effect between the wedge and the counterwedge into a thrusting force on the sword away from the drive pinion, but at the same time during the opening of the tensioning lever arrangement to make a shifting of the wedge in the direction toward the drive pinion possible. Thus, it is conceivable to provide the bottom of the wedge resting on the sword with a microcogging. A corresponding microcogging is then applied along the longitudinal sections on the top of the sword on which the wedge can move. The microcogging is designed in such a manner that the wedge can only be shifted in one direction relative to the sword along its longitudinal axis (this is in the direction of the drive pinion in the assembled sword).

If a chain unit or a sword is used in one of the embodiments of the rapid tensioning apparatus in accordance with the invention which sword has a spacer that is pretensioned by spring forces from the sword in the direction of the drive pinion, it is advantageous if the cover of the tensioning lever arrangement as well as the spacer located on the sword are designed in such a manner that they cooperate in such a manner that with the conclusion of the securing and tensioning procedure when the cover lowers onto the wedge and the counterwedge the spacer on the sword is pushed counter to the spring force in the longitudinal direction away from the drive pinion. In this manner the connection between the drive pinion and the spacer, which is no longer necessary after the securing of the chain unit on the main body of the chain saw, is loosened so that no frictional losses and wear arise during the operation of the chain saw.

To this end the spacer is advantageously provided on its side opposite the support surface on the spacer with a wedge-shaped nose. In order to cooperate with this wedge-shaped nose a counternose that is also designed wedge-shaped is formed on the cover. Upon the conclusion of the securing and tensioning procedure the nose and the counternose therefore act on one another in such a manner that the spacer on the sword is pushed counter to the spring force in the longitudinal direction away from the drive pinion.

In order to be able to use a sword in accordance with the invention on which a spacer is movably mounted even with a chain saw, in which the drive pinion was already mounted on the drive shaft before the assembly of the sword, such a chain saw is to be provided with a stop for this spacer. The spacer is to be shaped in such a manner that the spacer pre-tensioned by spring force in the direction of the drive pinion comes to rest on this stop before contacting the drive pinion. In this manner the spacer is protected during the mounting of the sword on the chassis of the chain saw from being damaged by an undefined running onto the drive pinion or the driveshaft.

In order to facilitate the mounting of the chain unit on the main body the support surfaces formed in the mounting area on the chassis for the support of the sword can be magnetically constructed or provided with a magnet. It can be achieved in this manner that after the chain unit has been laid on, it holds automatically so that the operator can actuate the tensioning lever arrangement without simultaneously holding the chain unit fast.

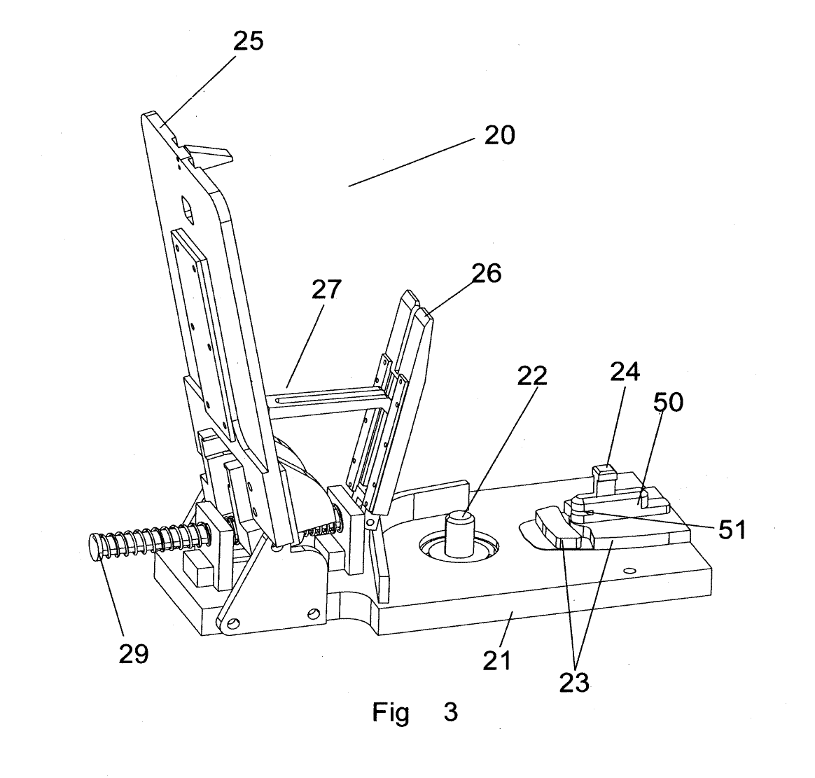

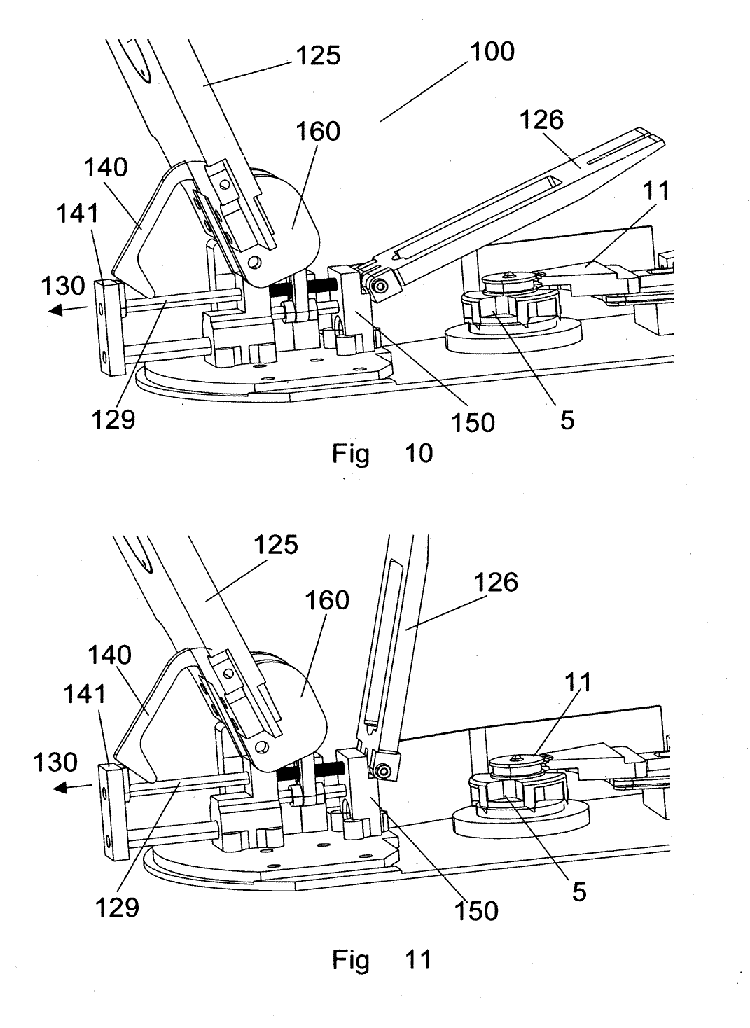

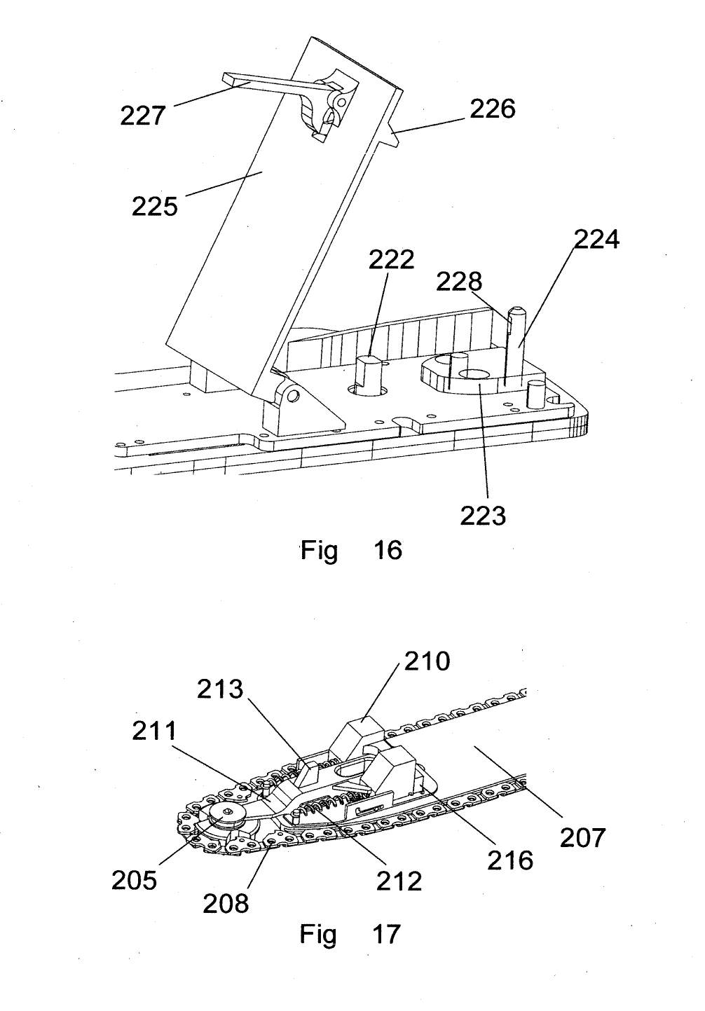

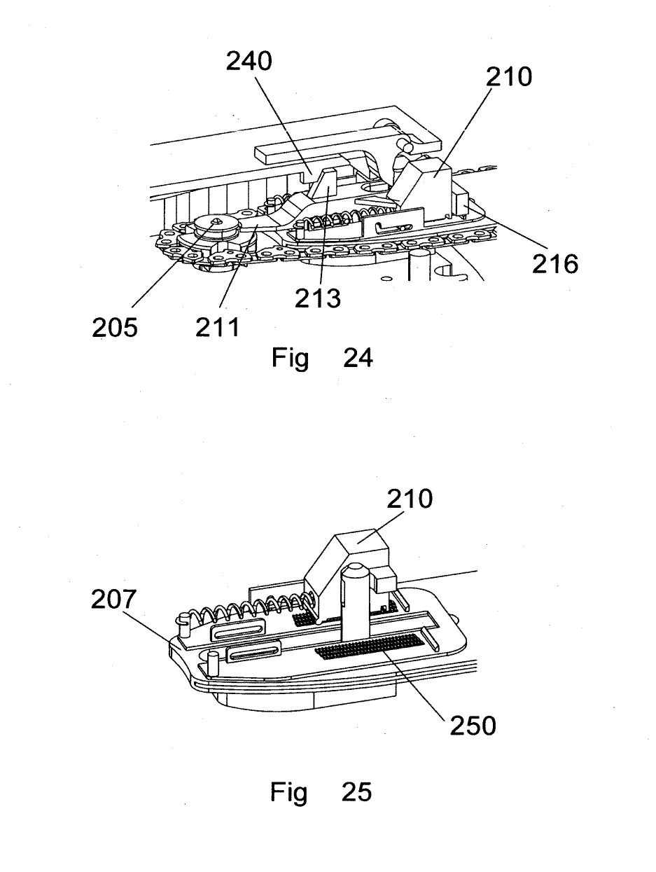

Possible advantageous embodiments of the rapid tensioning apparatus and of the chain unit in accordance with the invention are explained in detail using the following figures. FIGS. 3 to 9 show the cooperation of the chain unit in accordance with the invention with the rapid tensioning apparatus of the invention in accordance with a first advantageous embodiment. FIGS. 10 to 15 describe the alternative variant of this first advantageous embodiment of the rapid tensioning apparatus. A second advantageous embodiment of the rapid tensioning apparatus in accordance with the invention is described by FIGS. 16 to 23. FIGS. 24 and 25 show the formation and effect of a stop for the spacer by way of example using the embodiment according to FIGS. 16 to 23.

The figures show:

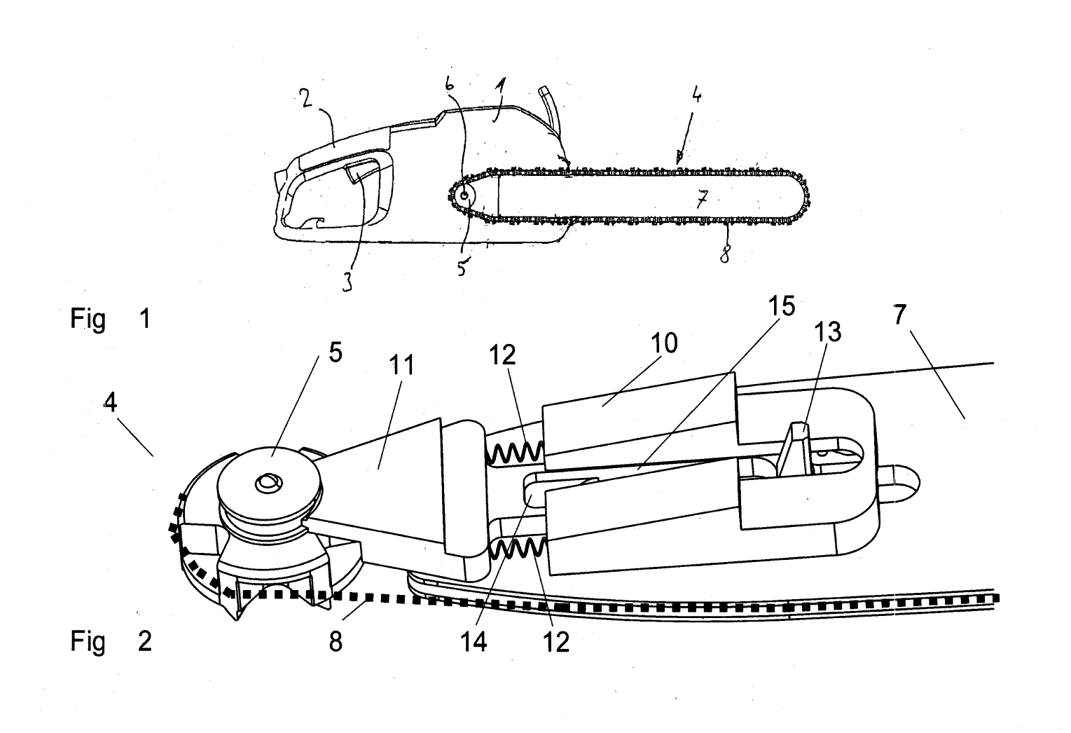

FIG. 1 schematically shows a chain unit 4 mounted on the main body 1 of chain saw.

FIG. 2 shows the chain unit 4, consisting of sword 7, drive pinion 5 and saw chain 8.

FIG. 3 shows a first advantageous embodiment of the rapid tensioning apparatus in accordance with the invention comprising chassis 21 with support surfaces 23 and counterholder 24, as well as tensioning lever arrangement 20 in the open state.

FIG. 4 shows the connection between cover 25 and counterwedge 26 via the connection web 27, as well as shows the rocker arm 28 with rod 29.

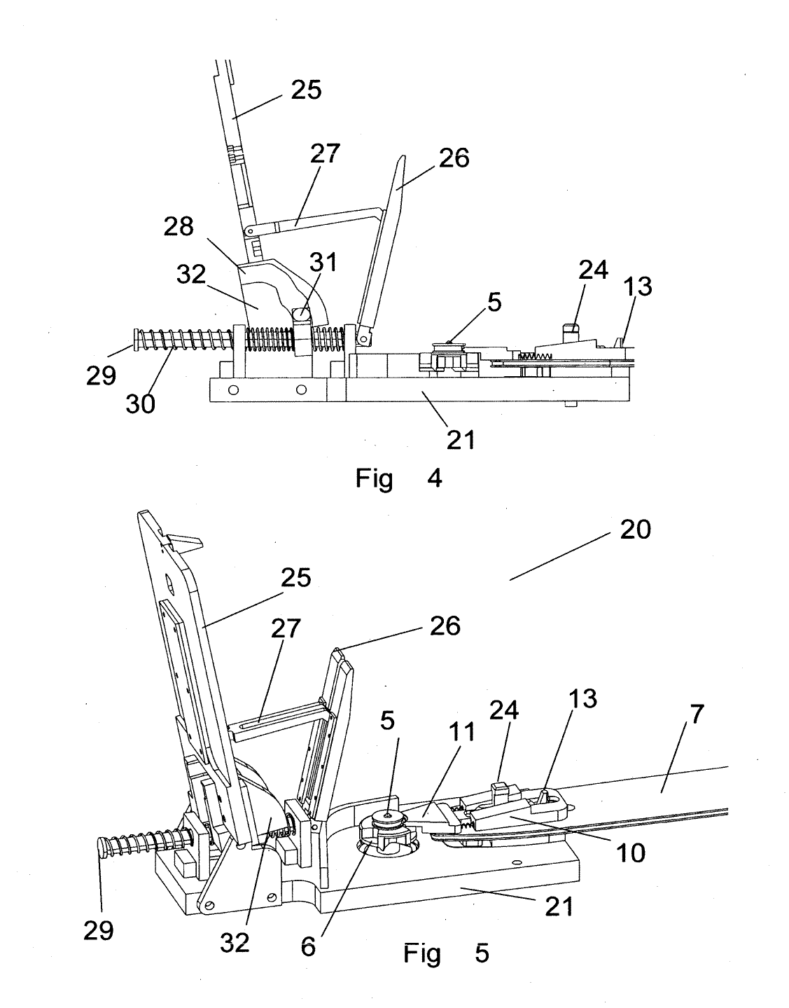

FIG. 5 shows the chain unit 4 placed on chassis 21 and together with tensioning lever arrangement 20.

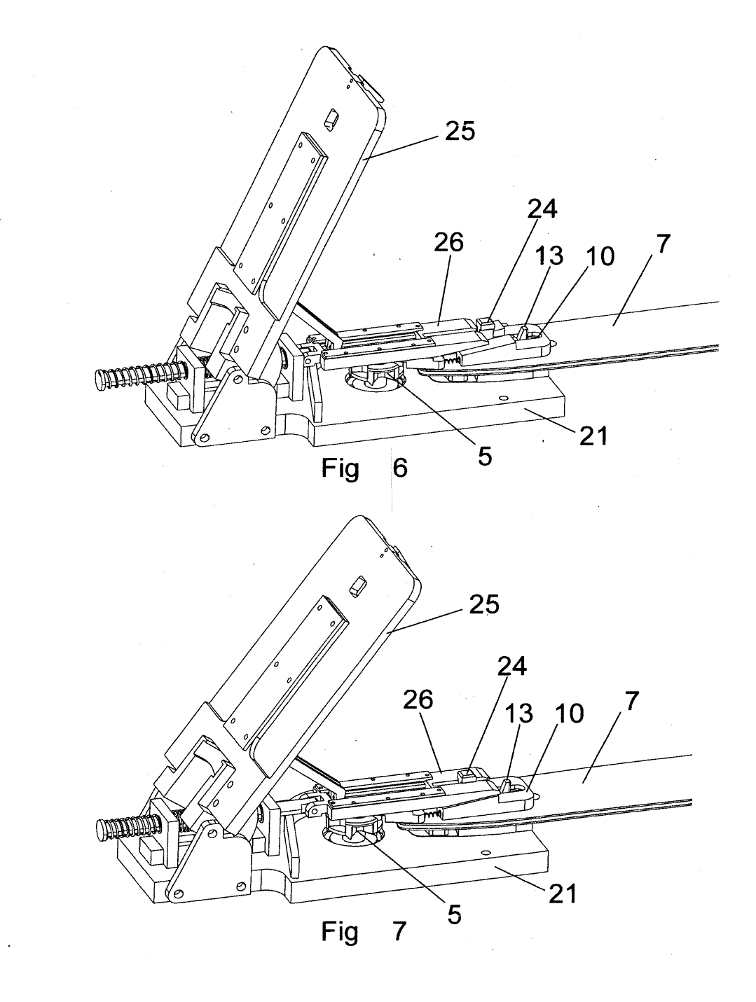

FIGS. 6 and 7 show the cooperation of wedge 10, counterwedge 26 and counterholder 24 that brings about the securing and the chain tension during the closing of cover 25.

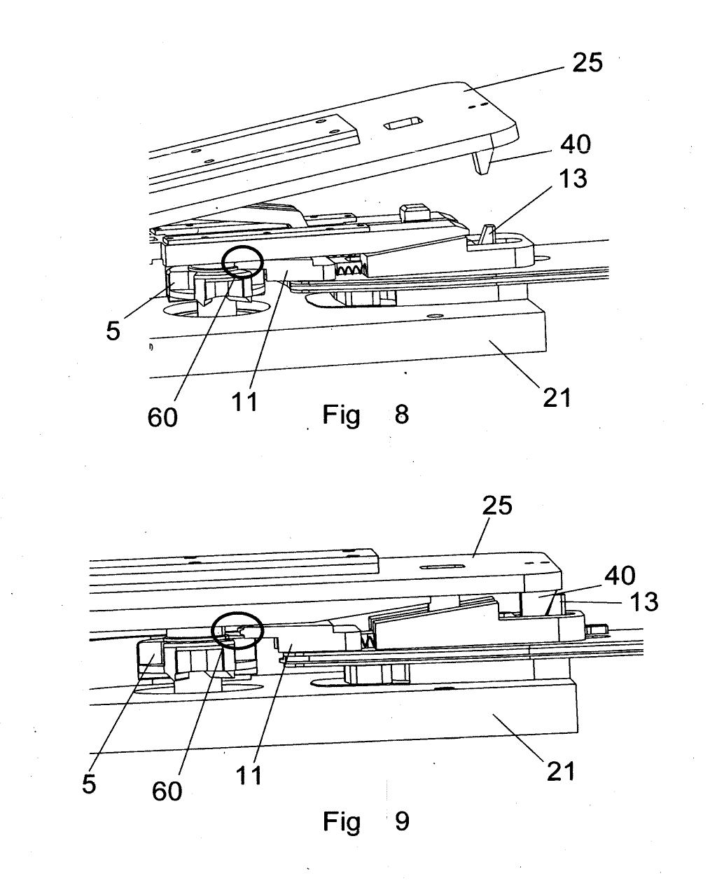

FIGS. 8 and 9 show the cooperation of the noses 13, 40 formed on the spacer 11 and the cover 25, which noses bring about the separation of the spacer 11 from the drive pinion 5.

FIGS. 10 to 13 show the mode of operation of an alternative variant to the first advantageous embodiment of the rapid tensioning apparatus from the FIGS. 3 to 9.

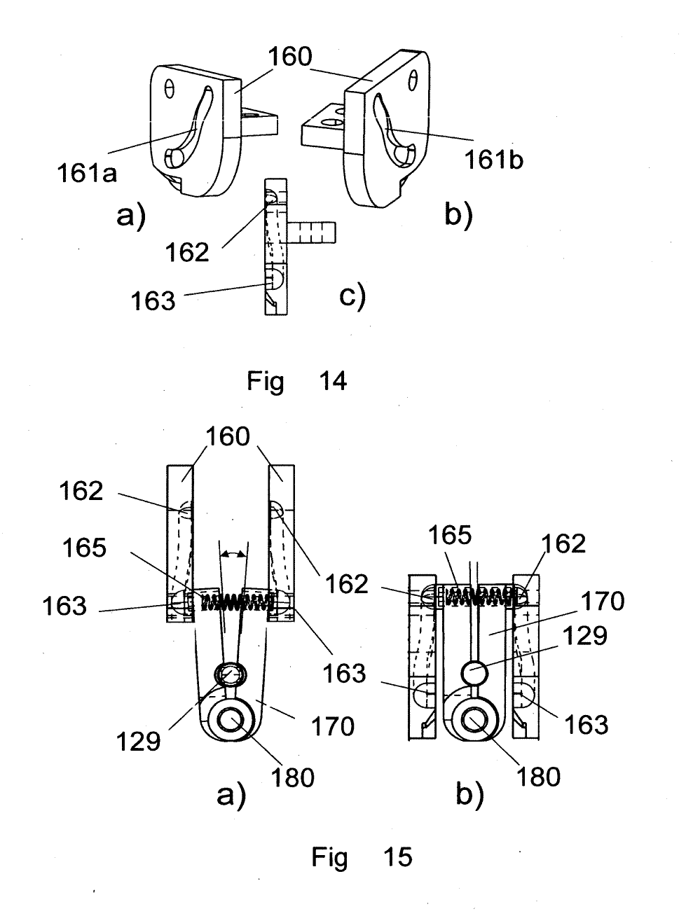

FIG. 14 shows details for the 3-D rocker arm 160 from FIGS. 10 to 13.

FIG. 15 shows details for the cooperation of clamping mechanism 170, rod 129 and rocker arm 160 in the framework of the alternative variant from FIGS. 10 to 13.

FIG. 16 shows the tensioning lever arrangement of a second advantageous embodiment of the rapid tensioning apparatus in accordance with the invention.

FIGS. 17 to 19 show an alternative embodiment of the chain unit and the sword in accordance with the invention, especially suitable for cooperating with the tensioning lever arrangement from FIG. 16.

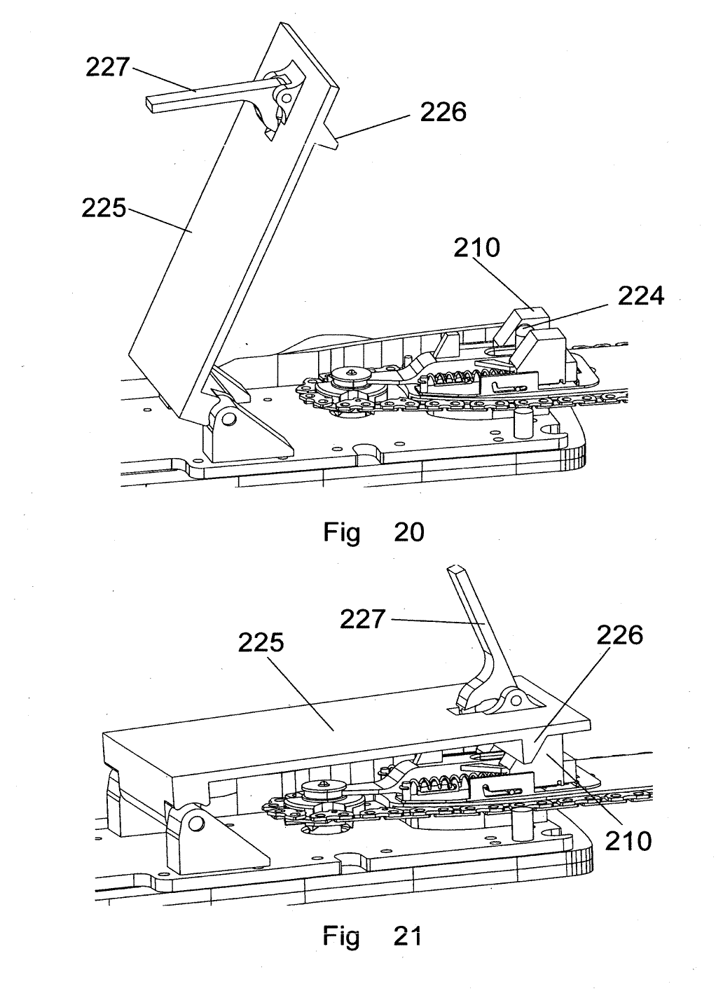

FIGS. 20 to 24 show the mode of operation of the second alternative embodiment of the rapid tensioning apparatus in accordance with the invention.

FIG. 25 shows the connection between wedge 210 and sword 207 by the microcogging 250.

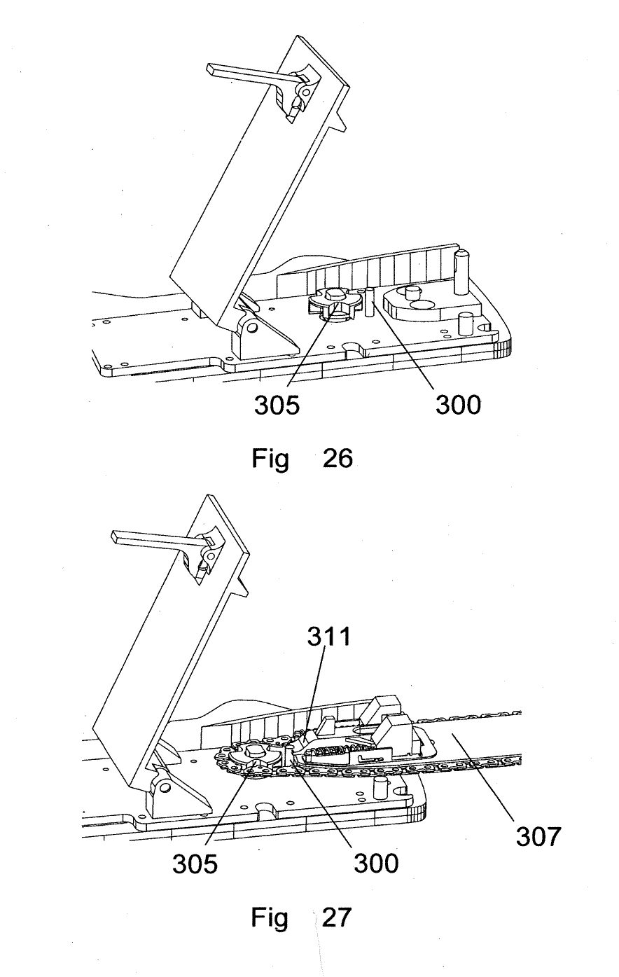

FIGS. 26 and 27 show the formation and effect of a stop for the spacer.

FIG. 1 schematically shows by way of example the main body 1 of a chain saw with the drive unit (not shown for driving a saw chain 8. A handle 2 with a switch 3 for turning the drive unit on and off is located on main body 1. The main body 1 is shown without the housing cover covering the chain drive during operation, so that the chain unit 4 comprising the sword 7, the saw chain 8 and the drive pinion 5 are visible. The drive pinion 5 is connected via a drive shaft 6 to the drive unit for driving the saw chain 12. The wedge and the spacer mounted on the sword 7 are not shown in this schematic view.

A possible advantageous embodiment of the chain unit 4 is shown in FIG. 2. In order to better visualize the individual detail of the chain unit 4 the representation of the saw chain 8 was shown here only in a sketched manner. The saw chain 8 runs as is customary around the drive pinion 5 and the sword 7. For this reason and for reasons of clarity the representation of the saw chain 8 is entirely dispensed with in the following figures.

A wedge 10 is mounted on sword 7 which wedge is preferably provided, as shown here, in the middle with a recess 15 along its longitudinal extent. Furthermore, a spacer 11 is attached on the sword 7 in such a manner that it can movably shift. This spacer is tensioned with springs 12 opposite wedge 10 in the direction of the drive pinion 5. In this manner the saw chain 8 is pre-tensioned, since spacer 11 presses the drive pinion 5 counter to the sword 7 into the saw chain 8. The spacer 11 also extends into the intermediate space formed in wedge 10 and comprises on it end a nose 13 projecting upward from wedge 10. The sword 7 as well as the spacer 11 have a recess 14 at least in the area of this intermediate space of the wedge 10 which recess preferably extends longitudinally along the entire intermediate space.

FIGS. 3 to 15 show by way of example an advantageous realization of an advantageous embodiment of the rapid tensioning apparatus in accordance with the invention. Here, FIG. 3 shows a tensioning lever arrangement 20 in the open state corresponding to this first alternative embodiment. A drive shaft 22 connected to the drive unit of the chain saw extends out of the chassis 21 of the main body 1 of the chain saw onto which shaft drive pinion 5 is placed during the mounting of the chain unit 4 on the main body edge. Furthermore, support surfaces 23 are provided on the chassis on which surfaces the sword 7 of the chain unit 4 comes to rest during the mounting of the chain unit on the main body 1. A counterholder 24 is preferably formed in the area of these support surfaces 23 and projects vertically over the support surfaces 23. The counterholder 24 penetrates the sword 7 as well as the spacer 11 in the intermediate space in the wedge 10 during the mounting of the chain unit 4 on the main body 1 in the area of the recess 14. In order to support the adjusting of the sword 7 a spring 50 is formed on chassis 21 in the area of the support surfaces 23 and extends, after the application of the chain unit 4, between its recesses into wedge 10 and sword 7. In order to avoid that this spring 50 hinders the longitudinal movement of the spacer 11 it is provided with a slot 51 into which the spacer 11 can penetrate unhindered in the framework of a longitudinal shifting.

The function of the rocker arm 28 and of the rod 29 coupled to it for transmitting the movement behavior resulting from the rotary movement of the cover 25 becomes clear from the cross-sectional drawing of FIG. 4. A rocker-arm holder 32 is attached to or formed on the cover 25, in which holder a rocker arm 28 setting the transfer of movement is formed. A holder for a sliding block 31 is attached to the rod 29 which block extends into the rocker arm 28 and slides along the rocker arm 28 upon a positional change of the rocker-arm holder 32 resulting from the rotation of cover 25 and thus transmits the movement information onto the rod 29. The rod 29 is pre-tensioned in a preferred manner via a spring 30 so that a longitudinal shifting of the counterwedge 26 against wedge 10 and counterholder 24 is supported.

The chain unit 4 in a preferred embodiment used in the tensioning lever arrangement 20 is shown in FIG. 5. As already previously described, the drive pinion 5 is connected to the drive shaft 6. The counterholder 24 projects over the wedge 10 in the intermediate space formed on it. In the left part of figure cover 25 and counterwedge 26 are shown that are rotationally supported and coupled to each other via a rocker arm 28 and a rod 29. Furthermore, in the exemplary embodiment shown here an additional coupling between cover 25 and counterwedge 26 is realized by a connection with 27. As a result of these coupling mechanisms a rotary movement of the cover 25 is converted into a rotary movement of the counterwedge 26 as well as into a longitudinal movement of the same.

This movement course and the resulting interaction of counterwedge 26 with the wedge 10 with the aid of the counterholder 24 is indicated in the following with FIGS. 6 and 7.

Regarding the situation described in the FIG. 5, in the situation shown in FIG. 6 the cover 25 is already partially inclined in the direction of the wedge 10. Consequently, the counterwedge 26 has already lowered onto the wedge 10.

If the cover 25 is pivoted further, the situation described with FIG. 7 results in which the counterwedge 26 is already being pressed on the wedge 10 by the counterholder 24 by longitudinal movement onto the wedge 10. At the same time the longitudinal movement of the counterwedge 26 also brings about an equidirectional longitudinal force onto the sword 7 so that the saw chain 8 is tensioned.

The FIGS. 8 and 9 show the decoupling between spacer 11 and drive pinion 5 in the contact area 60 that takes place during the complete closing of the cover. To this end a wedge-shaped nose 13 is formed on the spacer 11 on its side opposite the support surface on drive pinion 5. The part of the spacer 11 running in the recess 15 of the wedge 10 is provided with a recess 14 through which the counterholder 24 and optionally the spring 50 can penetrate during the mounting of the chain unit 4. In order to cooperate with the wedge-shaped nose 13 a counternose 40 which is also constructed like a wedge is formed on the cover 25. Nose 13 and counternose 40 act on one another upon the conclusion of the securing-and tensioning process when the cover 25 lowers onto the wedge 10 and the counterwedge 26 that the spacer 11 is thrust on the sword 7 counter to the spring force in the longitudinal direction away from the drive pinion 5. In this manner the connection between drive pinion 5 and spacer 11, which is no longer necessary after the securing of the chain unit 4 on the main body of the chain saw, is loosened.

The tensioning lever arrangement 100 shown in the FIGS. 10 to 13 represents a variant of the advantageous first alternative embodiment of the rapid tensioning apparatus in accordance with the invention described by FIGS. 3 to 9, which alternative variant relates to the cooperation of cover 125, rod 129 and counterwedge 126.

The cooperation of cover 125, rod 129 and counterwedge 126 is shown here in the final phase of the opening of the tensioning lever arrangement 100. The cover 125 is provided here with a lever arm 140 preferably mounted on it that rests on the rod 129, preferably by means of a pre-tensioning by a spring. During the opening of the tensioning lever arrangement 100 the support point of the lever arm 140 on the rod 125 moves in the direction of a stop 141. Upon reaching the stop, the pressure force acting from the lever 140 on the stop 141 brings about a shift of the rod 129 in direction 130. As a result of this shift the counterwedge 126 coupled to the rod 129 is pushed against the rocker arm 150 (FIG. 10) and is tilted upward, conditioned by its graduated design (FIG. 11).

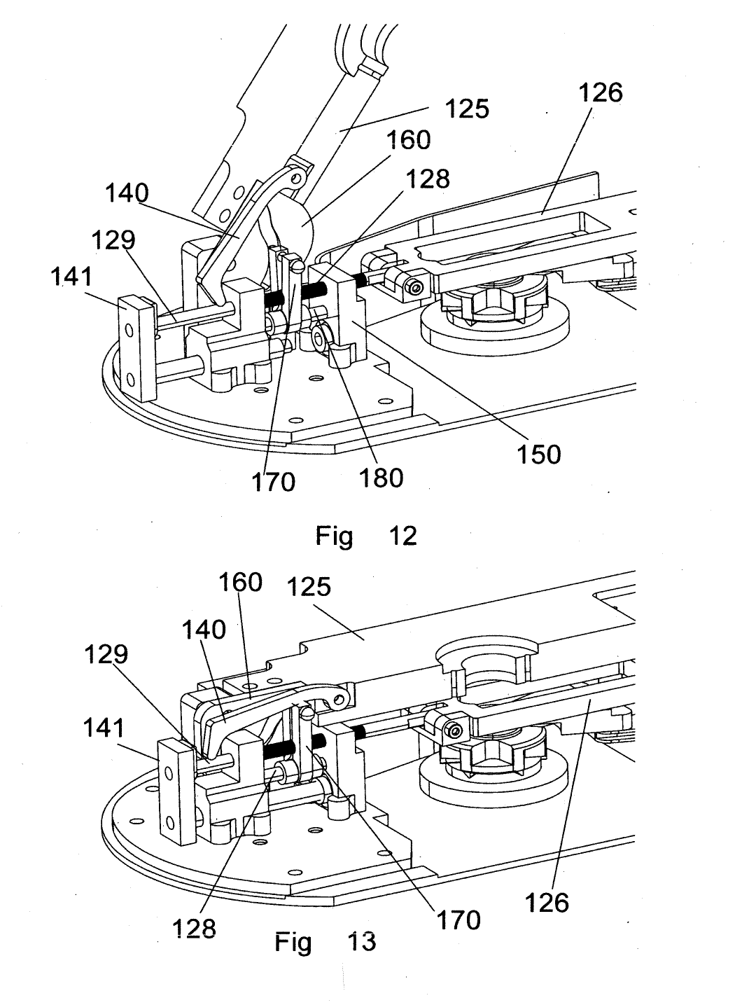

The FIGS. 12 and 13 show the cooperation of cover 125, rod 129 and counterwedge 126 during the closing of the tensioning lever arrangement 100. Here, the tensioning lever arrangement 100 in the area of the cover 125 of the lever 140 and of the rocker arm 160 is represented in a sectional view so that the clamping device 170 guided on the guide rail 180 becomes clearly visible. The clamping device 170 comprises 2 shank sections and surrounds the rod 129 in an area 128, whereby each of these two shank sections is guided in a rocker-arm track 161a and 161b of the rocker arm 160, preferably by sliding blocks fastened on it.

FIGS. 14 a) and b) show the two side parts of rocker arm 160 and the rocker-arm tracks 161a and 161b introduced into it. The course of the depth (3D course) of the rocker-arm tracks, which course varies with regard to the side surface, is clear from the section (shown in FIG. 14 c)) through one of the side parts 160. Whereas the rocker-arm track runs close to the edge of the side part in the upper area 162 of the rocker arm, the rocker-arm track dips deeper in the lower area 163 into the side part. This three-dimensional course of the rocker-arm track brings it about during the movement of the cover 125 of the tensioning lever arrangement 100 that the clamping device 170 connected to these rocker-arm tracks opens and closes.

This functionality is clarified in the sections (shown in the FIGS. 15 a) and b)) through rocker arm 160, rod 129, clamping device 170 and guide rail 180. FIG. 15 a) shows a section with open tensioning lever arrangement. In this instance the shank sections of the clamping device 170, which shank sections are connected to the rocker-arm tracks, are located in the areas 163 shifted lower in the side walls of the rocker arm 160. For this reason the clamping device 170 is in an open or drawn-apart state (indicated by the arrows in FIG. 15 a). As a result thereof, the clamping connection between clamping device 170 and the rod 125 loosens.

If the cover 125 is lowered in the direction of the sword 7, the shank sections of the clamping device 170 that are connected to the rocker arm 160 move along the rocker-arm tracks to their track sections 162 shifted toward the edge. This results in a clamping or in a fictional connection between clamping device 170 and rod 129 so that as a result the transformation of the rotary movement of the cover (125) into a linear movement of the rod 125 can be supported.

In order to further improve the fictional connection between clamping device 170 and rod 129 which is brought about by the clamping, in the exemplary embodiment shown in FIGS. 10 to 13 area 128, in which the rod 129 cooperates with the clamping device 170, is constructed with a gripping, in particular grooved surface.

The FIGS. 16 to 23 describe by way of example an advantageous realization of an alternative second embodiment of the rapid tensioning apparatus of the invention.

It is apparent from FIG. 16 that in this advantageous embodiment the tensioning lever arrangement comprises as essential element a cover 225 pivotably mounted on the chassis of the chain saw on which cover on the one hand a counterwedge 226 as well as a locking lever 227 are mounted. This cover 225 can be at the same time the covering for drive shaft 222 and sword support 223, which covering forms a part of the outer housing of the chain saw. The locking lever 227 is pivotably supported opposite the cover 225. In this embodiment of the tensioning lever arrangement an expensive mechanism for the transformation of the rotary movement of the cover 225 into a longitudinal movement of the counterwedge is eliminated. In order to cooperate with the locking lever 227 a locking pin 224 is formed on the chassis of the chain saw which pin has a recess 228 for engagement for the locking lever 227.

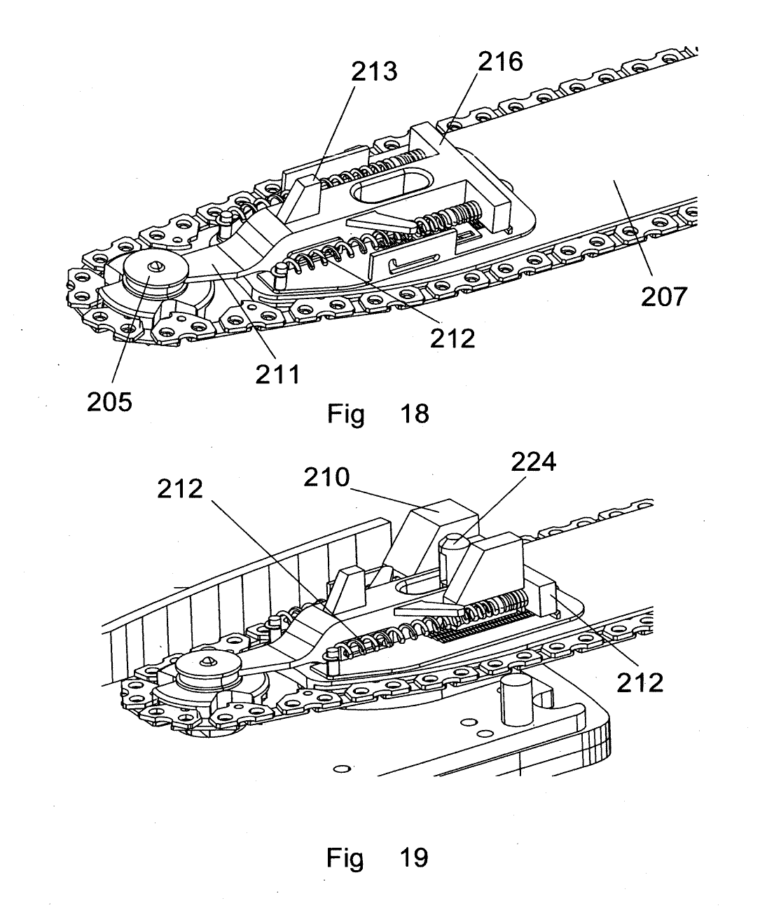

FIGS. 17 and 18 describe a chain unit in accordance with the invention and suitable for cooperating with the tensioning lever arrangement. This chain unit consists on the one hand of a drive pinion 205 that can be placed on the drive shaft 222, of a saw chain 208 and of a sword 207 on which a wedge 210 and a spacer 211 are mounted. In FIG. 18 this chain unit is shown again omitting the wedge 210 in order to show more clearly the formation of the spacer 211 pre-tensioned by spring force. The spacer 211 is pre-tensioned by two springs 212 opposite the sword 207 in such a manner that it is pre-tensioned by the spring force in the direction of the drive pinion 205. A transverse element 216 is formed on the spacer 211 on its end opposite the drive pinion 205. This transverse element 216 extends behind the wedge 210 shiftaably supported on the sword 207 in such a manner that upon a movement of the spacer 211 in the direction of the drive pinion 205 this wedge is also thrust in this direction.

FIG. 19 shows in section the chain unit (from FIGS. 17 and 18) mounted on the tensioning lever arrangement (from FIG. 16). It is apparent from the sectional view in FIG. 19 how the spring 212 penetrates the wedge 210. The penetration of locking pin 24 through the chain unit which takes place during the mounting of the chain unit is also apparent here.

The FIGS. 20 and 21 show the second embodiment of the rapid tensioning apparatus in accordance with the invention in the open and almost closed state (the complete locking by locking lever 227 has not yet taken place here). It is apparent from FIG. 21 how the counterwedge 226 located on the cover 225 comes to rest on the wedge 210 already in the almost completely closed state of the rapid tensioning apparatus in order to exert the necessary pressing force 230 and thrusting force 231 on the sword 207 with the completion of the locking.

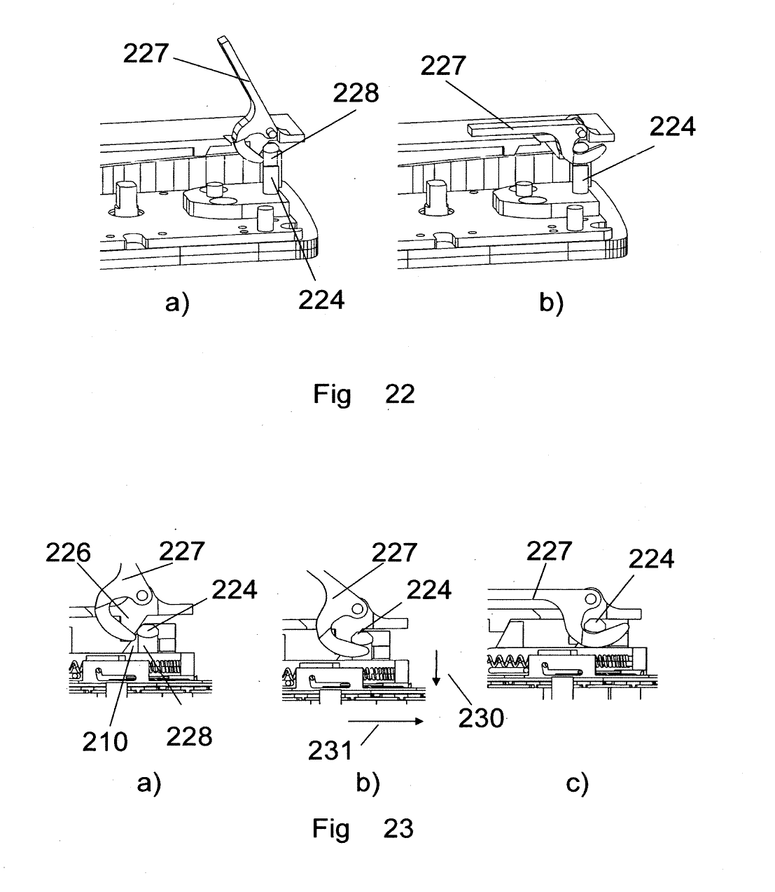

The section through the tensioning lever arrangement shown in FIGS. 22 a) and 22 b) shows the interaction of locking lever 227 and locking pin 224 upon the completion of the locking (for a better understanding of the mode of operation the chain unit was not shown here). As is apparent from the figures, the pivoting of the locking lever 227 from an open to a closed position results in an engagement of a hook formed on it into a recess 228 in the locking pin 224.

This engagement shown in the FIGS. 22 and its effect on the securing of the sword 207 on the chassis of the chain saw and the tensioning of the saw chain 208 that takes place at the same time is explained in detail in the sequence of the FIGS. 23 a) to c). These figures schematically represent the three essential steps in the locking of the rapid tensioning apparatus.

The situation shown in FIG. 23 a) corresponds substantially to the situation in FIG. 21. Here, the wedge 210 and the counterwedge 226 still rest loosely on one another. If in the following the locking lever 227 is now pressed downward in the direction of the cover 225, its hook-shaped formation engages into the recess 228 in the locking pin 224 (FIG. 23 b). The eccentric design of the hook-shaped recess brings about an increasing pressing of counterwedge 226 on the wedge 210 when penetrating into the recess 228 so that a pressing force 230 as well as a pushing pressure 231 are exerted on the sword 207 connected to the wedge 210. This brings it about that after the complete locking of the rapid tensioning apparatus (FIG. 23 c) the sword 207 is firmly secured on the chassis by the pressing force 230 and the saw chain 208 is tensioned by the pushing pressure.

As is apparent from the FIG. 24 a wedge-shaped nose 240 formed on the cover 225 sinks during a locking of the rapid tensioning apparatus onto a counternose 213 attached at a corresponding position on the spacer 211, as a result of which the spacer 211 is pushed with the conclusion of the locking procedure counter to the spring power applied by the springs 212 away from the drive pinion 205. If the locking is subsequently loosened again and the cover 225 raised, the nose 240 frees the counternose 213 again so that the spacer 211 is again pushed back by the spring force in the direction of the drive pinion 205. At the same time the spacer 211 also pushes the wedge 210 back in the direction of the drive pinion 205 again by its transverse element 216.

In order that on the one hand the pushing pressure can be transferred via the wedge 210 in a direction away from the drive pinion 205 onto the sword 207 but on the other hand the wedge 210 can be shifted by the spacer 211 during the opening of the cover 225 back in the direction toward the drive pinion 205, a microcogging is formed in the connection area between wedge 210 and sword 207, as shown in FIG. 25. In this representation the spacer 211 is not shown and also the wedge 210 is represented only partially in order to be able to show the surface of the sword 207 which surface lies under wedge 210. As is apparent from FIG. 23, the area of the sword 207 on which the wedge 210 can move is provided with a microcogging which cooperates with a corresponding microcogging 250 located on the side of the wedge 210 opposite this surface. In a conceivable embodiment this microcogging 250 is realized with a sawtooth-shaped structure, whereby the structure applied on the surface of the sword is formed by a plurality of sawtooth-shaped elevations. The elevations have a steep, in particular vertical flank on the side facing the drive pinion 205 whereas they are designed with a slight rise on the side facing away from the drive pinion 205.

FIG. 26 shows a chassis of a chain saw using the example of a rapid tensioning apparatus in accordance with the second alternative embodiment, in which chassis the drive pinion 305 is firmly set on the drive shaft. In order to also be able to use a sword in accordance with the invention, on which a spacer 311 is movably mounted, with such a chain saw, a stop 300 for this spacer 311 is provided on the chassis. The FIG. 27 shows a sword 307 in accordance with the invention and set on this type of chain saw. As the figure makes clear, the spacer 311 comes to rest here on the stop 300. A contact with the drive pinion 305 and any damage to the spacer 311 that might possibly occur from it can be effectively avoided as a result.

The invention is not limited to the advantageous embodiment described with the figures but rather can also be realized with other constructive means using the principle of the cooperation of a wedge mounted on a sword with a counterwedge acting on this wedge.

Thus, for example, it is not necessary that the counterholder acting on the counterwedge (in accordance with the first alternative embodiment of the rapid tensioning apparatus in accordance with the invention) or the locking pin cooperating with the locking lever (in accordance with the second alternative embodiment of the rapid tensioning apparatus in accordance with the invention) extends through the wedge, but rather it can of course also be connected to the chassis in another manner and/or be constructed in another manner.

1. A rapid tensioning apparatus for a chain saw with a drive unit for driving a saw chain running over a sword and over a drive pinion, whereby the drive pinion is connected via a drive shaft to the drive unit, whereby the sword is mounted on the chassis of the main body to be movable in a sliding manner on a support surface, whereby a wedge is mounted on the sword,
whereby a movable tensioning lever arrangement comprising a counterwedge is mounted on the chassis in the area of the drive shaft,
whereby the tensioning lever arrangement comprises a cover pivotably supported on the chassis which cover comprises an open position in which at least the saw chain and the sword are disassemblable from the main body of the chain saw, and comprises a closed position in which the saw chain rests under tension on the drive pinion and on the sword and the sword is firmly secured on the chassis of the main body,
and whereby the course of the movement of the elements of the tensioning lever arrangement during the transition from the open position to the closed position is designed in such a manner that the counterwedge comes to rest above the wedge,
so that the sword is secured by contact pressure on the chassis and at the same time the sword is pushed by pushing force longitudinally in a direction away from the drive pinion so that the saw chain is tensioned.

2. The rapid tensioning apparatus according to claim 1, wherein a counterholder is mounted in the area of the support surface of the sword, whereby this counterholder is designed to cooperate with the counterwedge, so that the contact pressure and pushing pressure between counterwedge and wedge is produced with the aid of a counterholder in that this counterholder prevents the counterwedge from escaping against the contact pressure.

3. The rapid tensioning apparatus according to claim 2, wherein a rocker arm is attached on the cover via which rocker arm the rotary movement of the cover is transformed into a longitudinal movement of a rod connected to the counterwedge
so that this rod delivers a rotary and longitudinal movement of the counterwedge.

4. The rapid tensioning apparatus according to claim 3, wherein the rod is pre-tensioned by at least one spring so that the longitudinal movement of the rod is supported by the spring force.

5. The rapid tensioning apparatus according to claim 3 4, wherein a movably mounted connecting web is introduced between cover and counterwedge.

6. The rapid tensioning apparatus according to claim 3, wherein it comprises a clamping mechanism that activates the rocker arm connected to the cover of the tensioning lever arrangement and acts on the rod connected to the counterwedge.

7. The rapid tensioning apparatus according to claim 6, wherein the rod is constructed in the area of its cooperation to the clamping mechanism with a gripping, in particular grooved surface.

8. The rapid tensioning apparatus according to claim 6, wherein the rod is constructed in the area of the engagement of the clamping mechanism with an elliptical cross-section,
or that in the case of a circular cross section of the rod the clamping mechanism is designed in such a manner that the cross section of the passage for the rod is constructed elliptically there.

9. The rapid tensioning apparatus according to claim 3, wherein a lever is movably fastened on the cover of the tensioning lever arrangement which lever acts upon the opening of the cover on a stop fastened on the rod and thus transforms the rotary movement of the cover into a linear movement of the rod.

10. The rapid tensioning apparatus according to claim 2, wherein the cover of the tensioning lever arrangement is provided with a fastening element by means of which it is automatically or manually fastened after the securing of the sword and after tensioning of the saw chain.

11. The rapid tensioning apparatus according to claim 1, wherein the counterwedge is connected to the cover for covering the drive pinion and to the end of the sword which end is located in its vicinity and in particular is constructed on or fastened to it,
and that this cover produces the counterforce on the counterwedge in cooperation with a locking apparatus so that the counterwedge is prevented from escaping against the contact pressure.

12. The rapid tensioning apparatus according to claim 11, wherein the locking apparatus is formed by a locking lever pivotably supported on the cover and by a locking pin formed on the chassis of the chain saw, whereby in particular the locking pin is provided with a recess into which the locking lever can engage, via a hook-shaped formation.

13. The rapid tensioning apparatus according to Claim 1, wherein the cover of the tensioning lever arrangement and a spacer located on the sword are constructed in such a manner, in particular by shifting the cover and the spacer with a nose and a counternose cooperating with the latter so that they cooperate in such a manner that upon the closure of the securing and tensioning procedure the spacer on the sword is pushed in the longitudinal direction away from the drive pinion.

14. The rapid tensioning apparatus according to claim 1, wherein a stop is formed on the chassis of the chain saw in the vicinity of the drive pinion on which stop a spacer mounted on the sword and pre-tensioned in the direction of the drive pinion comes to rest.

15. The rapid tensioning apparatus according to claim 1, wherein the driveshaft and the drive pinion are constructed in such a manner that the drive pinion is mountable on the drive shaft as part of a chain unit during the mounting of this chain unit on the chassis of the chainsaw.

16. The rapid tensioning apparatus according to claim 1, wherein the support surfaces formed in the mounting area of the chassis for supporting the sword are constructed magnetically or are provided with a magnet.

17. A chain unit for a rapid tensioning apparatus of a chain saw according to claim 1, comprising a drive shaft, a sword and a saw chain running around the drive pinion and the sword in a guide groove,
whereby a wedge is mounted on the sword,
whereby a spacer is mounted on the sword in such a manner that it is movable in a sliding manner,
whereby the spacer is pre-tensioned relative to the wedge by springs in the direction of the drive pinion,
whereby the spacer, starting from the springs, exerts such a force on the drive pinion that it is pressed counter to the sword into the saw chain.

18. A sword for a chain unit according to claim 17, wherein a wedge is mounted on the sword.

19. The sword according to claim 18, wherein a spacer is mounted on the sword in such a manner that it is shiftably moveable.

20. The sword according to claim 18, wherein the wedge is mounted on the sword in such a manner that it is shiftably moveable along a longitudinal axis of the sword,
whereby a spring force acts on the wedge in such a manner that upon the opening of the tensioning lever arrangement of the rapid tensioning apparatus the wedge is pushed on the sword in a direction of the end of the sword adjacent to the drive pinion.

21. The sword according to claim 20, wherein the wedge is connected to the sword via a microcogging, for which in particular the wedge bottom resting of the sword is provided with a microcogging that cooperates with a microcogging on the longitudinal section of the sword on which latter microcogging the wedge moves,
whereby the microcogging is designed in such a manner that the wedge is shiftable relative to the sword only in the direction toward the end of the sword adjacent to the drive pinion.

22. The sword according to claim 18, wherein in the wedge mounted on the sword preferably the middle part as well as, in a corresponding manner, the area of the sword located underneath it are recessed in particular as a longitudinal groove, and that during the placing of the chain unit on the support surface a spring supporting the adjusting of the sword is enabled to penetrate this recess.
